(19) United States
(12) Patent Application Publication
(10) Pub. No.: US 2025/0383153 A1
(43) Pub. Date: Dec. 18, 2025

(54) AN INDIRECTLY HEATED ELECTRICAL ROTARY KILN AND METHODS OF REPLACING A HEATING ELEMENT THEREOF

(71) Applicant: METSO METALS OY, Espoo (FI)

(72) Inventors: Caleb WIESZCZYK, York, PA (US); Eric WAGNER, York, PA (US)

(21) Appl. No.: 18/878,713

(22) PCT Filed: Jul. 1, 2022
(86) PCT No.: PCT/FI2022/050483

§ 371 Date: Dec. 24, 2024

(51) Int. Cl. F27B 7/34; F27B 7/08; F27D 11/00; H05B 3/62

(52) U.S. Cl. CPC F27B 7/34; F27B 7/08; F27D 11/00; H05B 3/62

(57) ABSTRACT

An indirectly heated electrical rotary kiln including a longitudinal inner shell for conveying process material therethrough, the inner shell being rotatable about its longitudinal axis. The rotary kiln further includes a stationary shroud arranged along the length and around the cross-sectional perimeter of the inner shell, thereby surrounding said inner shell, and a shroud module detachable from the remaining shroud, and formed as a longitudinal section and a cross-sectional perimeter segment of the shroud. The rotary kiln further includes an electrical heating element provided on the shroud module on an inside of the shroud, said heating element being configured to heat the inner shell, when in use. Methods for replacing a heating element of the rotary kiln are also disclosed.

### FIELD OF THE DISCLOSURE

The present disclosure relates to indirectly heated rotary kilns, and more particularly to such rotary kiln which are electrically heated. The present disclosure further concerns methods of replacing a heating element of such an indirectly heated electrical rotary kiln.

### BACKGROUND OF THE DISCLOSURE

Rotary kilns are used to raise material to a high temperature in a continuous process. Typically, a process material is continuously fed through a cylindrical shell, which is simultaneously rotated, causing the process material to mix and advance along the cylindrical shell.

In an indirectly heated rotary kiln, an inner shell is commonly arranged within a stationary shroud, which insulates the inside of the kiln from the surrounding environment. Moreover, the process material within the shell is heated by introducing heat thereto through the shell. That is, heat is introduced from outside the inner shell. Conventionally, this is done by arranging burners in the intermediate space between the inner shell and the shroud. However, a great portion of the thermal energy is not used for heating the process material but escapes along with the exhaust gasses.

Electrical heaters have been used instead of burners in attempt to improve thermal efficiency of indirect rotary kilns. As opposed to burners, heat is not carried away from the kiln by exhaust flow. However, electrical heating elements have a limited lifetime and need to be replaced periodically. Typically, the heating elements need to cool down before they can be removed, which results in substantive down time of the kiln, when replacing heating elements.

### BRIEF DESCRIPTION OF THE DISCLOSURE

An object of the present disclosure is to provide an indirectly heated electrical rotary kiln which allows for easy replacement of electrical heating elements. It is a further object of the present disclosure to provide methods for replacing a heating element of such an indirectly heated electrical rotary kiln

The object of the disclosure is achieved by the rotary kiln and methods which are characterized by what is stated in the independent claims. The preferred embodiments of the disclosure are disclosed in the dependent claims.

The disclosure is based on the idea of providing the shroud surrounding the inner shell with one or more shroud modules, on which heating elements are arranged. This allows removal of a shroud module without the need of shutting down the entire process in order to replace only a portion of the element.

Consequently, a shroud module with a defective or worn heating element can be replaced with another shroud module with new or refurbished heating elements with minimal effect on the overall operation of the kiln. Alternatively, a shroud module with a defective of worn heating element can be replaced with a dummy shroud module (i.e., a shroud module with no heating elements), thereby preventing heat from escaping from within the shroud during replacement of heating elements from the removed shroud module. Furthermore, the missing amount of heat input from the removed shroud module may be compensated by temporarily increasing the heat output of other shroud modules.

According to a first aspect of the present disclosure, an indirectly heated electrical rotary kiln is provided.

The rotary kiln comprises a longitudinal inner shell configured for conveying process material (i.e., process feedstock) therethrough so as to be subjected to thermal treatment, when in use. The inner shell is arranged rotatable about its longitudinal axis. Suitably, the inner shell is further configured such that the process material is advanced along the length of the inner shell as the inner shell is rotated.

The rotary kiln further comprises a stationary shroud arranged along the length and around the cross-sectional perimeter of the inner shell, thereby surrounding said inner shell. The shroud acts as an insulating barrier preventing heat from escaping from the kiln. Suitably, the shroud may be provided with refractory lining and/or thermal insulation material.

Particularly, the rotary kiln further comprises a shroud module formed as a longitudinal section and a cross-sectional perimeter segment of the shroud. That is, the shroud module forms a longitudinal portion of the length of the shroud and an angular portion of the perimeter of the shroud. Moreover, said shroud module is detachable from the remaining shroud. Most suitably said shroud module is detachably attached to the remaining shroud.

The rotary kiln further comprises an electrical heating element provided on the shroud module on an inside of the shroud. Such a heating element is configured to heat the inner shell, when in use. Advantageously, such an electrical heating element is of a non-contact type heating element, such as a radiant heater (e.g., infrared heater) or an induction heater.

Preferably, but not necessarily, a reflector is arranged between the heating element and the shroud module, thereby directing heat produced by the heating element away from the shroud module. Suitably, an insulation layer may also be provided between the reflector and the remaining shroud module. Concurrently, the reflective and insulative layers serve to increase the overall thermal efficiency of the kiln by promoting heat transfer in the direction of the process material and away from the surroundings.

The shroud module may naturally comprise a plurality of heating elements. The heating elements are suitably provided at a distance from the inner shell, along the cross-section perimeter thereof. This enables a greater area coverage of the inner shell by the heating elements, as opposed to heating element at a single angular position.

Preferably, but not necessarily, the shroud module comprises a plurality of sockets configured for operationally coupling with corresponding heating elements in a detachable manner. Such a modular interface between the heating element and the shroud module allows both fast replacement of heating elements and also flexible customization of the shroud module for different thermal power outputs. For example, a shroud module at first position of the rotary kiln could be provided with a certain number of heating element, while an otherwise similar shroud module at a second position of the kiln could be provided with another number of heating element, thereby allowing optimization of the thermal profile of the rotary kiln for a certain application. The ability to finely tune heat input can be especially advantageous when compared to the prior art in applications that require a specific amount of time at a given temperature.

Preferably, but not necessarily, the shroud module may comprise a detachable coupling allowing the shroud module to be detachably coupled to an electrical power source, so as to provide power for the heating elements. For example, the shroud module may comprise a plug-and-socket-interface for coupling the shroud module with an electrical power source.

Preferably, but not necessarily, heating elements extend for a distance along the length of the inner shell. For example, the heating elements may extend parallel with the inner shell, or horizontally (i.e., parallel with the length of the rotary kiln).

In an embodiment of the first aspect according to the disclosure, an internal shape of the shroud, at least at a position of the shroud module, conforms with an external shape of the inner shell at a distance therefrom. That is, the internal shape of the shroud does not need to identically trace the curvature of the inner shell but should follow the general geometry thereof. For example, if the internal shape of the shroud is defined by a plurality of discrete, planar heating elements, the inclinations of the heating elements may be arranged so as to conform with the outer circumference of the inner shell. That is, the internal cross-sectional shape of the of the shroud could be a polygonal approximation of a circular cross-sectional shape of the outer surface of the inner shell. Such an arrangement allows for placing the heating element(s) closer to the inner shell, while simultaneously minimizing the intermediate volume between the inner shell and the shroud, thereby increasing the efficiency of heat transfer between the heating element and the process material within the inner shell.

In another embodiment of the first aspect according to the disclosure, the shroud module extends laterally along a bottom side the inner shell. In other words, the shroud module extends horizontally below the inner shell. Unless otherwise stated, the term lateral is used in the context of this disclosure to describe a horizontal direction transverse to the longitudinal direction. Most suitably, the shroud module also comprises one or more heating elements provided at a position below the inner shell. This allows for the inner shell to be heated at a position where the process material is primarily located within the inner shell during operation, thereby minimizing heat losses.

In another embodiment of the first aspect according to the disclosure, the shroud module extends vertically along a lateral side of the inner shell (i.e., lateral sides defined on opposing sides a vertical longitudinal central plane of the inner shell). In other words, the shroud module may extend upwardly on a flank side of the inner shell. Unless otherwise stated, the term vertical is used in the context of this disclosure to describe a direction transverse to a horizontal plane. Most suitably, the shroud element comprises one or more heating elements provided at such a flank position of the inner shell. This allows for heat to be directed to the inner shell at a greater area thereof.

Preferably, but not necessarily, the shroud module extends vertically along a lateral side of the inner shell, at least on a side towards which the process material is pushed by the rotation of the inner shell. This further allows for the inner shell to be heated at a position where the process material is primarily located within the inner shell during operation, thereby minimizing heat losses.

Preferably, but not necessarily, the shroud module extends vertically along a lateral side of the inner shell only on a side towards which the process material is pushed by the rotation of the inner shell. Such an arrangement facilitates removal of the shroud element towards a lateral direction, as the inner shell does not interfere with such a removal path of the shroud element.

In another embodiment of the first aspect according to the disclosure, the shroud module extends over at least a 90 deg cross-sectional perimeter segment of the shroud below a longitudinal central axis of the inner shell. Such an arrangement is considered to provide for both a suitable location for and a sufficient cross-sectional coverage of the heating elements with respect to position of the process material within the inner shell.

In another embodiment of the first aspect according to the disclosure, the shroud module is retractable from the remaining shroud in a lateral direction away from the inner shell. That is, the shroud module, the remaining shroud are configured such that the shroud module can be removed from the remaining shroud with a lateral translational movement without lifting or rotating the shroud module. This further facilitates removal and replacement of a shroud module.

In another embodiment of the first aspect according to the disclosure, the shroud module comprises rollers or wheels on which it may be supported for retracting said shroud module away from the remain shroud. Such an arrangement allows the shroud module to be rolled away from the remaining, e.g., along the plant floor or an associated platform. Moreover, such wheels or rollers may be configured to run on associated tracks, thereby ensuring a pre-determined retraction path of the shroud module and facilitating reconnection of said module.

In another embodiment of the first aspect according to the disclosure, the intermediate space within the shroud and exterior to the inner shell is subjected to an atmosphere at a pressure exceeding that of the environment surrounding the rotary kiln. Keeping the intermediate space under positive pressure protects the heating elements by preventing contaminants from entering the intermediate space. Contaminants, such as dust, may sinter on the heating elements, which may decrease the efficiency of the heating element or even damage them. To this end, the rotary kiln may further comprise a blower configured to feed air into the intermediate space at a pressure exceeding that of the environment surrounding the rotary kiln. Suitably, a filter may be provided upstream of the blower.

Although embodiments and variants of the first aspect of the present disclosure have been discussed above primarily with reference to a single shroud module, it should be noted that the rotary kiln is suitably provided with a plurality of shroud modules.

Preferably, but not necessarily, the rotary kiln may comprise a plurality of shroud modules provided along the length of the kiln, suitably spaced apart from each other.

Preferably, but not necessarily, the rotary kiln may comprise a pair of shroud modules provided on opposing lateral sides of the inner shell. Suitably, said pair of shroud modules suitably are aligned with respect to each other along the length of the kiln.

For example, the pair of shroud modules combined may extend over at least a 90 deg, or even up to a 180 deg cross-sectional perimeter segment of the shroud below a longitudinal central axis of the inner shell.

Moreover, the rotary kiln may comprise a plurality of such shroud module pairs, in which case the pairs of shroud modules are advantageously provided along the length of the kiln, suitably spaced apart from each other.

It should be noted that the first aspect of the present disclosure encompasses any combination of two or more embodiments, or variants thereof, as discussed above.

According to a second aspect of the present disclosure, a method is provided for replacing a heating element of the rotary kiln according to the first aspect of the present disclosure, while suitably simultaneously operating the rotary kiln. That is, the method allows replacement of the heating element without the need for halting feed of the process material through the kiln.

A first shroud module, having at least a first heating element, is detached from the remaining shroud. Subsequently, said at least first heating element is replaced with at least a second heating element. Finally, the first shroud module, together with the at least second heating element, is re-attached to the remaining shroud. Suitably, the rotary kiln is simultaneously operated,

Preferably, but not necessarily, after detaching the first shroud module, a dummy shroud module may be attached to the remaining shroud so as to cover an opening thereof from which the first shroud element was detached. Moreover, prior to re-attaching the first shroud module, the dummy shroud module is detached form the remaining shroud so as to expose said opening into which the first shroud element may then be reattached. This prevents heat from escaping the kiln while the heating elements of the first shroud modules are being replaced.

According to a third aspect of the present disclosure, a method is provided for replacing a heating element of the rotary kiln according to the first aspect of the present disclosure, while suitably simultaneously operating the rotary kiln. That is, the method allows replacement of the heating element without the need for halting feed of the process material through the kiln.

A first shroud module, having at least a first heating element, is detached from the remaining shroud, and a second shroud module with at least a second heating element is attached to the remaining shroud.

Subsequently, one or more heating element of the first shroud module may be replaced, while the second shroud module is in place. Then the second shroud module can be detached from the remaining shroud, and the first shroud module can be re-attached to the remaining shroud.

### BRIEF DESCRIPTION OF THE DRAWINGS

In the following the disclosure will be described in greater detail by means of preferred embodiments with reference to the accompanying drawings, in which

FIG. 1 is a schematic cross-sectional representation of a rotary kiln according to an embodiment of the present disclosure, in which a shroud module is attached to the remaining shroud;

FIG. 2 is a schematic cross-sectional representation of the rotary kiln of FIG. 1 with the shroud module being retracted away from the remaining shroud;

FIG. 3 is schematic representation of a section of a rotary kiln according to an embodiment of the present disclosure illustrated as a perspective view;

FIG. 4a is a schematic representation of a shroud module, and

FIG. 4b is a schematic representation of a dummy module.

### DETAILED DESCRIPTION OF THE DISCLOSURE

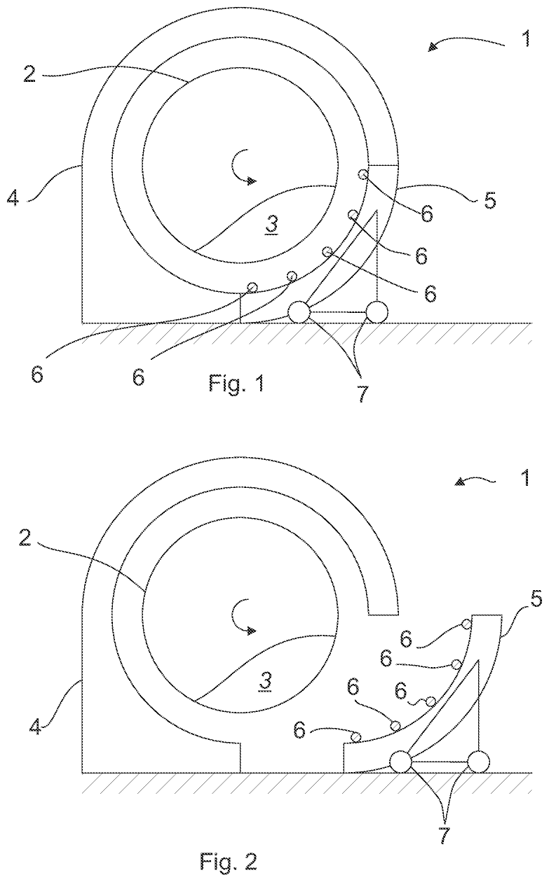

FIG. 1 illustrates a schematic cross-sectional representation of a rotary kiln 1 according to an embodiment of the present disclosure, as seen long the length of the kiln 1. A stationary shroud 4 is arranged along the length and around the perimeter of an inner shell 2. FIG. 1 represents the rotary kiln 1 during operation, i.e., the inner shell is rotated about its longitudinal axis in the direction of the arrow in centre of inner shell. Process material 3 is fed into, and advanced through the inner shell 2, while being subjected to thermal treatment by the heat produced by the heating elements 6. The rotation of the inner shell 2 pushes the process material 3 towards a lateral side of the inner shell 2.

The rotary kiln 1 comprises a shroud element 5 forming a cross sectional perimeter segment of the shroud 4. Although not seen form FIG. 1 the shroud element 5 also forms a longitudinal section of the shroud 4. Moreover, the shroud element 5 extends laterally below and vertically along a lateral side of the inner shell 2 towards which the rotation of the inner shell 2 pushes the process material. In the arrangement of FIG. 1, the internal shape of the shroud 4, including the that of the shroud module 5, conforms with the external shape of the inner shell 2. In the arrangement of FIG. 1, the shroud element 5 extends over a 90 deg perimeter segment of the shroud 4.

The shroud element 5 comprises a plurality of heating elements 6 along the cross-sectional perimeter of the inner shell 2, at a distance therefrom. Although not illustrated in FIG. 1 the heating element 6 are suitably operationally coupled in corresponding sockets arranged on the shroud element 5. Also not seen from FIG. 1, the heating elements 6 extend for a distance along the length of the inner shell 2.

FIG. 2, in turn, illustrates a schematic cross-sectional representation of the rotary kiln shown in FIG. 1 with the shroud module 5 retracted away from the remaining shroud 4. Particularly, the shroud module 5 has been retracted away in a lateral direction away from the remaining shroud 4. FIG. 2 also illustrates rollers 7 on which the shroud module 5 may be supported during retraction. For example, such rollers 7 could be fixed to the shroud module 5, or alternatively, temporarily attached to the shroud module 5 for the removal thereof.

FIG. 3 shows a section of a rotary kiln according to an embodiment of the present disclosure as a schematic representation illustrated as a perspective view. The inner shell 2 of the rotary kiln 1 is housed within the shroud 4 in a manner similar to that of the drawings discussed above. The rotary kiln 1 comprises multiple shroud modules 5 arranged longitudinally one after another, each shroud module 5 forming a longitudinal section and a cross-sectional perimeter segment of the shroud 4. Particularly, FIG. 3 shows one of the shroud modules 5 being detached from the remaining shroud 4 and retracted away therefrom. The shroud modules 5 are supported on rollers 7 (not denoted in FIG. 3) allowing the shroud modules 5 to be easily drawn out of the remain shroud 4. Moreover, the shroud modules 5 are equipped with flanges 8 for positioning and securing the shroud modules 5 to the remaining shroud 4. For example, the flanges may have openings, through which pins protruding from the remaining shroud 5 extend, when the shroud module 5 is properly positioned in place.

Although the arrangement of FIG. 3 shows shroud modules 5 being positioned one after another along the length of the rotary kiln 1, the shroud modules 5 could alternatively, or additionally, be spaced apart from each other. In such a case, the remaining shroud 4 may advantageously extend into the space between the spaced apart shroud modules 5. Moreover, although the arrangement of FIG. 3 shows the shroud modules 5 being arranged on a single lateral side of the rotary kiln 1, shroud modules 5 could be provided on both lateral sides of the rotary kiln 1. In such a case, shroud modules may could be arranged as pairs on laterally opposing sides of the rotary kiln 1.

It should also be noted that, for the purpose of clarity, FIG. 3 does not illustrate heating elements of the shroud modules 5.

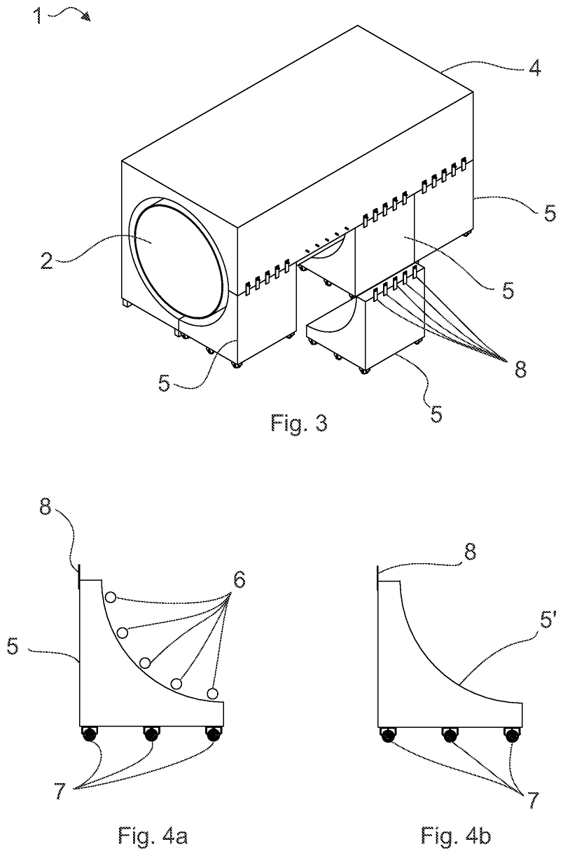

FIG. 4a illustrates a shroud module 5 of the arrangement of FIG. 3 as seen as a side view. Particularly, the shroud module 5 is equipped with heating elements 6. FIG. 4b, in turn, illustrates a dummy module 5′ which may be used to cover an opening of a detached shroud element 5, while said shroud element 5 is being serviced. Particularly, the dummy module 5′ is not equipped with heating elements.

### LIST OF REFERENCE NUMERALS

1 rotary kiln
2 inner shell
3 process material
4 shroud
5 shroud module
5′ dummy module
6 heating element
7 roller
8 flange

1.-17. (canceled)

18. An indirectly heated electrical rotary kiln, comprising:
a longitudinal inner shell configured for conveying process material therethrough so as to be subjected to thermal treatment, when in use, the inner shell being rotatable about its longitudinal axis
a stationary shroud arranged along the length and around the cross-sectional perimeter of the inner shell, thereby surrounding said inner shell,
wherein the rotary kiln comprises a shroud module formed as a longitudinal section and a cross-sectional perimeter segment of the shroud, wherein said shroud module is detachable from the remaining shroud, and
wherein the rotary kiln further comprises an electrical heating element provided on the shroud module on an inside of the shroud, said heating element being configured to heat the inner shell, when in use.

19. The rotary kiln according to claim 18, wherein the shroud module comprises a plurality of heating elements provided at a distance from the inner shell, along the cross-sectional perimeter thereof.

20. The rotary kiln according to claim 19, wherein the shroud module comprises a plurality of sockets configured for detachably operationally coupling with corresponding heating elements.

21. The rotary kiln according to claim 19, wherein the heating elements extend for a distance along the length of the inner shell.

22. The rotary kiln according to claim 18, wherein an internal shape of the shroud, at least at a position of the shroud module, conforms with an external shape of the inner shell at a distance therefrom.

23. The rotary kiln according to claim 18, wherein the shroud module extends laterally along a bottom side the inner shell.

24. The rotary kiln according to claim 18, wherein the shroud module extends vertically along a lateral side of the inner shell.

25. The rotary kiln according to claim 24, wherein the shroud module extends vertically along a lateral side of the inner shell, at least on a side towards which the process material is pushed by the rotation of the inner shell.

26. The rotary kiln according to claim 25, wherein the shroud module extends vertically along a lateral side of the inner shell only on a side towards which the process material is pushed by the rotation of the inner shell.

27. The rotary kiln according to claim 18, wherein the shroud module extends over at least a 90 deg cross-sectional perimeter segment of the shroud below a longitudinal central axis of the inner shell

28. The rotary kiln according to claim 18, wherein the shroud module is retractable from the remaining shroud in a lateral direction away from the inner shell.

29. The rotary kiln according to claim 18, wherein the shroud module comprises rollers (7) or wheels on which it may be supported for retracting said shroud module away from the remain shroud.

30. The rotary kiln according to claim 18, characterized by further comprising a plurality of shroud modules provided along a length of the kiln, suitably spaced apart from each other.

31. The rotary kiln according to claim 18, characterized by further comprising a pair of shroud modules provided on opposing lateral sides of the inner shell, said pair of shroud modules suitably being aligned with respect to each other along the length of the kiln.

32. The method of replacing a heating element of the rotary kiln according to claim 18, characterized by comprising the steps of:
detaching a first shroud module from the remaining shroud, said first shroud module having at least a first heating element;
replacing said at least first heating element with at least a second heating element, and
re-attaching the first shroud module with the at least second heating element to the remaining shroud,
while simultaneously operating the rotary kiln.

33. The method according to claim 32, characterized by further comprising, after detaching and prior to re-attaching the first shroud module, the steps of:
attaching a dummy shroud module to the remaining shroud so as to cover an opening thereof from which the first shroud element was detached, and
detaching the dummy shroud module form the remaining shroud so as to expose said opening into which the first shroud element may be reattached.

34. A method of replacing a heating element of the rotary kiln according to the claim 18, comprising the steps of
detaching a first shroud module having at least a first heating element from the remaining shroud, and
attaching a second shroud module with at least a second heating element to the remaining shroud,
while simultaneously operating the rotary kiln.
